(19) United States
(12) Patent Application Publication
(10) Pub. No.: US 2019/0058869 A1
(43) Pub. Date: Feb. 21, 2019

(54) STEREOSCOPIC IMAGE-CAPTURING APPARATUS

(71) Applicant: STEREOLABS, ORSAY (FR)

(72) Inventors: Cécile SCHMOLLGRUBER, ORSAY (FR); Edwin AZZAM, ORSAY (FR); Olivier BRAUN, ORSAY (FR); Ludovick RAZAFIMANDIMBY, ORSAY (FR)

(21) Appl. No.: 16/079,167

(22) PCT Filed: Mar. 1, 2017
(86) PCT No.: PCT/FR2017/050465

§ 371 Date: Aug. 23, 2018

(30) Foreign Application Priority Data
Mar. 3, 2016 (FR) 16 51 805

(51) Int. Cl. H04N 13/246; H04N 13/25; H04N 5/232; H04N 13/271; G06T 7/80

(52) U.S. Cl. CPC H04N 13/246; H04N 13/25; G06T 7/85; H04N 13/271; H04N 5/23296

(57) ABSTRACT

A stereoscopic image-capturing apparatus includes a first digital image sensor, a second digital image sensor synchronized with the first sensor, at least one optical zoom with variable focal distance and associated with the first sensor or the second sensor, a digital zoomer for performing a digital zoom on a digital image coming from the second sensor, a resizer for choosing a resizing value to align an image to be aligned and coming from the first sensor and an image to be aligned and coming from the second sensor, and a depth map producer for producing a depth map.

### TECHNICAL BACKGROUND

The invention falls within the field of stereoscopic image capturing, for example for stereoscopic video.

Stereoscopic image capturing systems are known using different techniques, providing depth information.

For example, systems use a monoscopic digital image sensor sensitive to visible light coupled to both an infrared pulse generator and a monoscopic image sensor sensitive to infrared waves. Using the time-of-flight of the infrared waves reflected by the viewed objects, the distances, pixel by pixel, of these objects from the image capturing device are determined. Infrared, for example near-infrared, is for instance used to avoid polluting the information with visible light. The visible light image is provided with an associated depth map, indicating the distances of the visible objects for each pixel. Disruptions may be caused by the environment, such as the sun, or infrared waves sources, such as a second sensor used nearby.

Alternatively, scanners are known sending pulses by visible light segment on the scene, which is scanned quickly by a mechanical orientation system of the pulse generator. The mechanics are complex, involve mirrors, and are fairly costly, cumbersome and fragile. The scanner can be blinded in case of ambient cloudiness.

Systems are known using a light source illuminating the scene using a cloud with a structured form, the deformation of which is analyzed with a monoscopic sensor. Such a system requires the use of a light generator in addition to the stereoscopic image-capturing apparatus, which is restrictive.

These different systems have the drawback of being dependent on the sending of light information into the scene, which makes them precarious.

Also known are stereoscopic systems using two monoscopic sensors arranged next to one another in a predefined manner and from which one determines, by triangulation, a depth map. The depth information coming from two sensors, it is described as disparity information. Reference is also made to disparity cartography.

For example, the bumblebee2 camera is a stereoscopic camera with two sensors for generating disparity images.

Furthermore, WO2012/165717 describes an apparatus for generating a stereoscopic image by recording an image for the left eye and an image for the right eye, the two sensors having different resolutions. The convergence is controlled, the outermost parts are excised from the high-resolution image, and the scale of said image is adjusted.

These different technologies do not offer a device that is easy to implement, robust, energy-efficient and protected against the environment, and that provides an associated image with depth information.

### DEFINITION OF THE INVENTION

To resolve the problems identified above, proposed is a stereoscopic image-capturing apparatus comprising a first digital image sensor, a second digital image sensor synchronized with the first sensor, at least one optical zoom with variable focal distance associated with the first sensor or the second sensor, and means for performing a digital zoom on a digital image coming from the second sensor, the apparatus additionally comprising means for choosing a resizing value to align an image to be aligned coming from the first sensor and an image to be aligned coming from the second sensor, and means for producing a depth map associated with images captured on a same date by the first and second sensors by using images coming from the second sensor modified by the application by the digital zoom means of resizing by said resizing value, the means for choosing a resizing value being configured to be implemented at least when the focal distance of the optical zoom is modified, in order to calibrate the stereoscopic image-capturing apparatus.

In certain embodiments, the stereoscopic image-capturing apparatus has the following features:

the means for producing a depth map implement, to produce the map, a rotation between an image to be exploited coming from the first sensor and an image to be exploited coming from the second sensor;

the means for choosing a resizing value determine, in order to choose the resizing value, at least one rotation on one, two or three axes (preferably three axes) between an image to be aligned coming from the first sensor and an image to be aligned coming from the second sensor;

the means for choosing a resizing value use an extraction of points of interest of an image to be aligned coming from the second sensor in its form as captured by the second sensor before any resizing, an extraction of points of interest of an image to be aligned coming from the first sensor, and matching of the points of interest taken from the two images;

the means for choosing a resizing value use an extraction of points of interest of an image to be aligned coming from the second sensor in a form modified at least by the application of a resizing by the digital zoom means, an extraction of points of interest of an image to be aligned coming from the first sensor and matching of the points of interest extracted from the two images;

the second sensor is a monochrome sensor and the first sensor is a color sensor with a higher resolution than the monochrome sensor;

the means for choosing a resizing value are configured to be implemented when the device is turned on or reset;

the means for selecting a resizing value implement several digital zooms with resizing with different values on said digital image captured by the second sensor in order to obtain a plurality of modified digital images, and use a comparison of each of said modified digital images with said digital image captured by the first sensor;

the means for choosing a resizing value implement obtaining, beforehand, a summary resizing value between said digital image captured by the first sensor, and said digital image captured by the second sensor synchronously, and refining of the summary value into a refined resizing value.

### LIST OF FIGURES

FIG. 1 shows a first embodiment of an apparatus according to the invention.

FIG. 2 shows a second embodiment of an apparatus according to the invention.

FIG. 3 shows a first embodiment of functions carried out in the invention.

FIG. 4 shows a second embodiment of functions carried out in the invention.

FIG. 5 shows a third embodiment of functions carried out in the invention.

### DETAILED DESCRIPTION OF THE INVENTION

FIG. 1 shows a stereoscopic image-capturing apparatus 10 according to one embodiment of the invention. It comprises a first digital image monoscopic sensor 11, polychromatic (for example RGB), and high resolution. The stereoscopic image-capturing apparatus 10 comprises a second digital image monoscopic sensor 12, monochromatic, and with a lower resolution than that of the first sensor 11. The two sensors are temporally synchronized by a component (not shown) generating and sending a clock signal to the two sensors.

The two sensors 11 and 12 are connected to a computing unit 13, which receives the images in the form of a digital data electronic transmission. All of the electrical elements of the apparatus 10 are powered by a battery 14 or a storage cell, or any small and lightweight independent power source. The latter provides the electrical power to the computing unit 13. The computing unit 13 is sized to be powered by the battery 14. The image-capturing apparatus 10 is preferably mobile, transportable and contained in a housing. It does not require a sector-type power supply.

The first sensor 11 produces images qualified as main images, while the second sensor 12 produces images qualified as slave images.

The data coming from the two sensors 11 and 12 is concatenated in the form of a single image comprising both pieces of information, before being processed by the computing unit 13.

An example of concatenation may be as follows: Pixel from the main sensor (Ym, Um or Vm)+Pixel from the monochrome secondary sensor (Ys)=Pixel from the final image (Ym, Um, or Vm, Ys).

The resulting image is usable by a processor, which would know how the pixels are sequenced in order to decode the two images.

One approach is to concatenate each pixel of the main image with the pixel of the slave image. In the case of different resolutions, some pixels of the main image do not have corresponding pixels, and are therefore completed with 0s.

Pixel n of the final image is:

[Y(main px.n)][U(main px.n)][Y(slave px n)]

A second approach is to concatenate the complete list of pixels of the main image with the complete list of pixels of the slave image successively. The advantage of this method is that it is not necessary to add 0s.

The final image therefore reads:

[Y(main px 1)][U(main px 1)] . . . [Y(main px n)][V(main px n)][Y(slave px 1)]. . . [Y(slave px.2)]. . . [Y(slave px n)]

The concatenation can be done by the main processor 13. In this case, the main processor directly sends the necessary electrical power to the two sensors by a dedicated electronic track.

One or the other of the digital sensors is provided with an optical zoom. In the illustrated embodiment, the two digital sensors 11 and 12 are each provided with an optical zoom, respectively referenced 21 and 22. The focal length of one or the other of the optical zooms can be modified, by a user acting manually, or by a processor or a controller acting to adjust the apparatus. Both focal lengths may optionally be modified on a same occasion.

Furthermore, the main processor 13 comprises means 131 for performing a digital zoom on a digital image coming from the second sensor 12.

The main processor 13 also comprises means 132 for choosing a resizing value to align the main image IP to be aligned coming from the first sensor and a slave image to be aligned IE coming from the second sensor.

The main processor 13 also comprises means 133 for producing a depth map associated with images captured on the same date by the first and second sensors 11 and 12.

The means 132 for choosing a resizing value are configured to be implemented when the focal distance of the optical zoom or one of the optical zooms is modified.

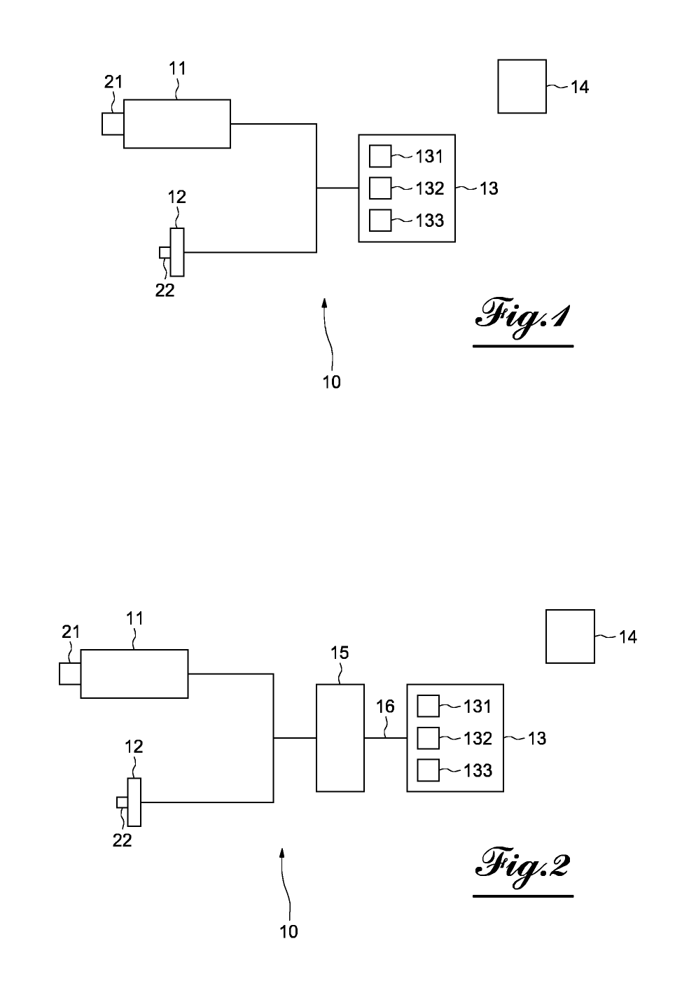

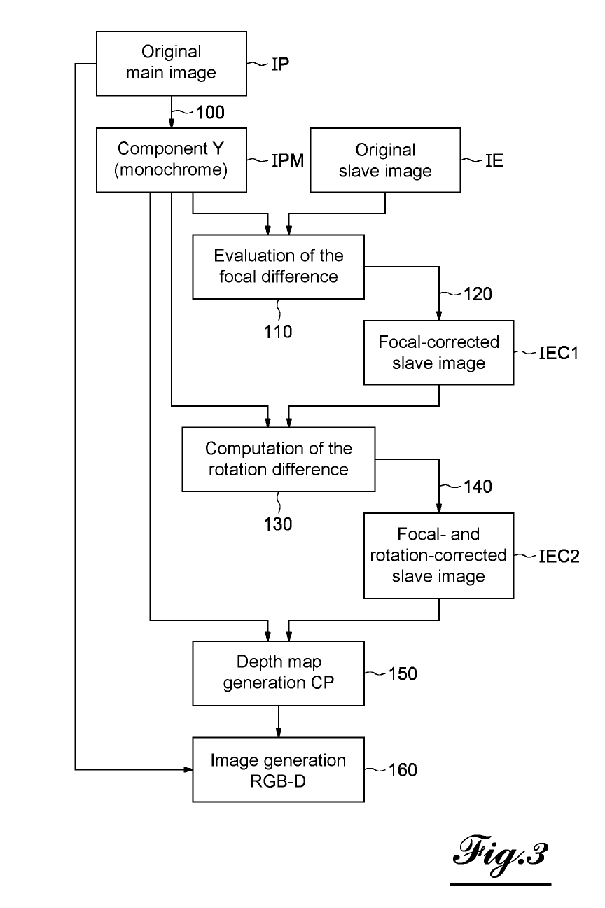

Alternatively, in one advantageous embodiment shown in FIG. 2, the concatenation can be done on an off-board secondary processor 15, connected to the sensors 11 and 12, and connected to the main processor by a cable 16 of the USB type. In this particular case, the power supply is transmitted via the cable 16 to the secondary processor 15, which in turn transmits the necessary power to the two sensors 11 and 12 via a dedicated electronic track.

The concatenation of the data is used to guarantee the synchronization of the images from the two sensors 11 and 12. This makes it possible to prevent the computing unit 13 from recovering two images in two different procedures.

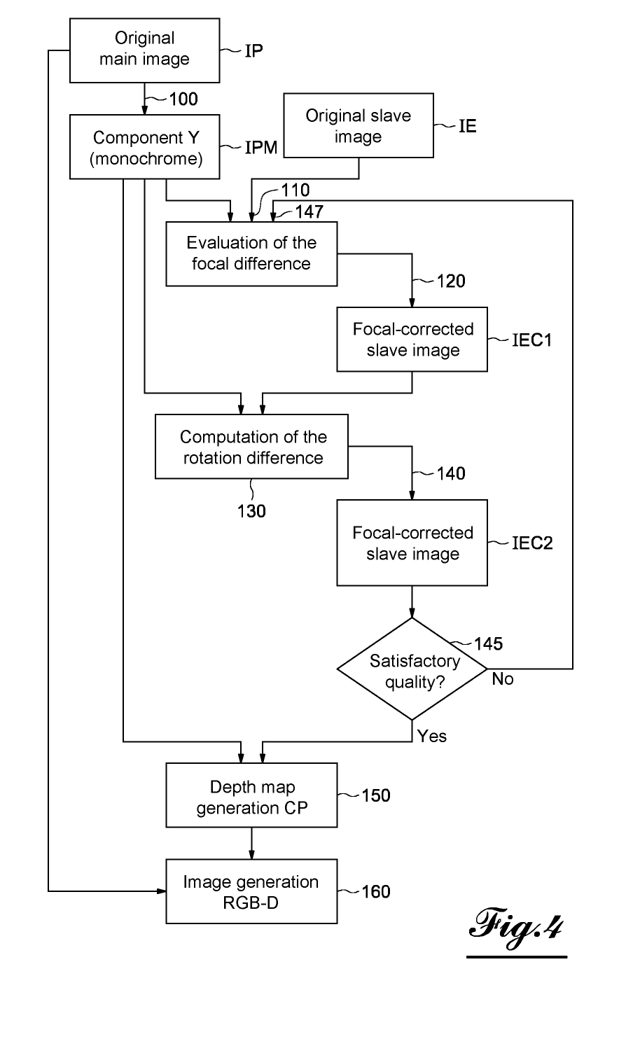

FIG. 3 shows a first embodiment of image processing by the stereoscopic image-capturing apparatus 10, and more specifically by the computing unit 13. The main images IP and the slave images IE are provided to the computing unit 13 by the sensors 11 and 12, for example in the aforementioned concatenated form.

A recalibration of the secondary sensor 12 is done, by using a main image IP and the temporally corresponding slave image IE. The recalibration can also be done by using several main images IP and the temporally corresponding slave images IE.

The recalibration of the second sensor (or calibration of the stereoscopic device) consists of determining parameters for modifying slave images IE in order to align them on the main images IP.

The recalibration is done during the initialization of the system. It can be done again when the focal distance of an optical zoom associated with one or the other of the sensors is modified.

The main images IP are subject to an extraction 100 of the luminance component Y. This is generally a first color channel of the main image. The extraction step 100 makes it possible to have monochromatic main images IPM.

The processing continues with a step 110 for evaluating the ratio between the focal lengths of the monochromatic main image IPM and the slave image IE. This step can be carried out using an extraction of points of interest, such as the corners or contours of an object, or any other technique, using all or part of the information available in the images IE and IPM. In place of the image IPM, the image IP can be used for this step. Step 110 can be carried out by the means 132 for choosing a resizing value. The points of interest are identified in the corresponding images (with the same date), and the corresponding points are found, through a recognition and matching process.

The processing continues with a step 120 for modifying the slave image IE by resizing (or rescaling) by using the focal length ratio determined in step 110. This step provides a corrected slave image IEC1. IEC1 is a virtual slave image that comes from a slave sensor having the same focal distance as the main sensor 11. The step is carried out by the means 131 for performing a digital zoom.

The processing continues with a step 130 for estimating angular differences, preferably over three complementary axes in space, between the image captures, by comparing the corrected slave image IEC1 and the monochromatic main image IPM. This step can be carried out using an extraction of points of interest, such as the corners or contours of an object, or any other technique, using all or part of the information available in the images IEC1 and IPM. In place of the image IPM, the image IP can be used for this step. Again, the points of interest are identified in the corresponding images (with the same date), and the corresponding points are found, through a recognition and matching process.

The processing continues with a step 140 for modifying the corrected slave image IEC1 by rotations, preferably over three complementary axes in space, by using the angular offsets determined in step 130. This step provides a corrected slave image IEC2. IEC2 is a virtual slave image that comes from a slave sensor having the same focal distance as the main sensor 11, and placed in the same location.

The processing continues with a step 150 for generating a depth map CP (or disparity map), from the monochromatic main image IPM (or optionally the original main map IP) and the corrected slave image IEC2. One example operating mode can be the use of a semi-global match algorithm by block, or more generally the description in each pixel of the main image and the search for the counterpart pixel in the recalibrated slave image. Step 150 is be carried out by the means 133 for generating a depth map.

The processing continues by a step 160 for generating a color image integrating the disparity (or depth) RGB-D. This is for example done by assembling the main image IP and the depth map CP in a single image in a side-by-side format.

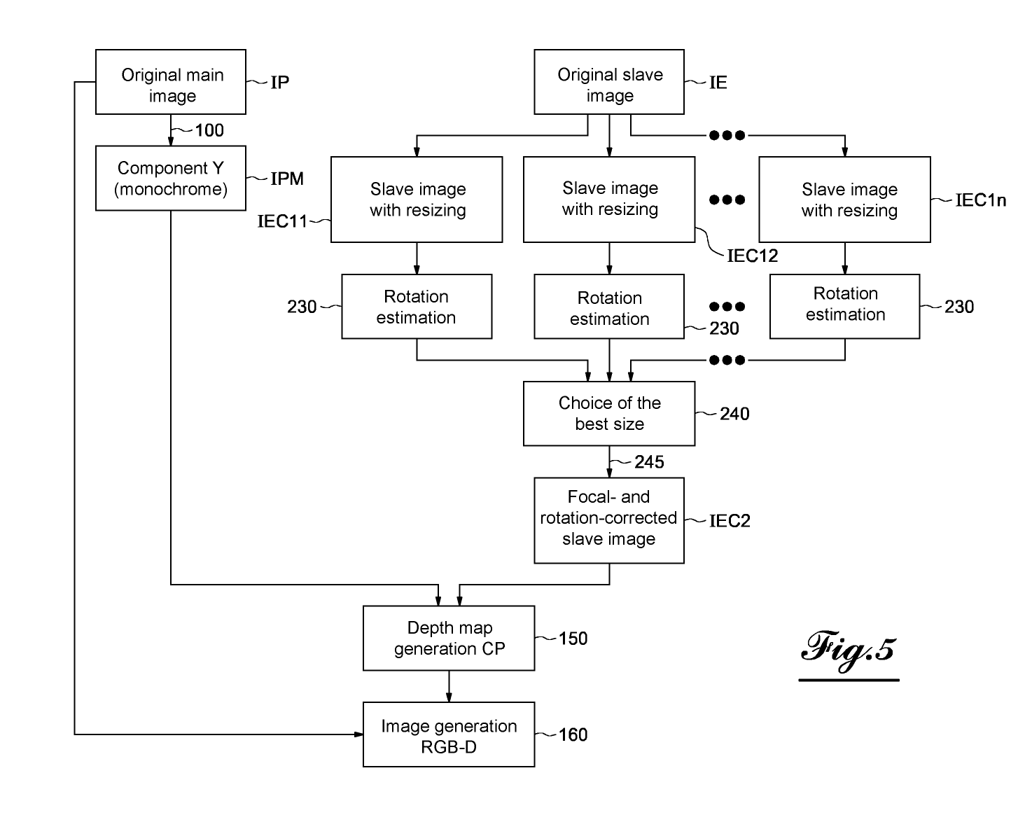

FIG. 4 shows a second embodiment of image processing by the computing unit 13.

It is similar to the embodiment of FIG. 2, with the addition, once the corrected slave image IEC2 is obtained by resizing and rotation, of a test step 145, to verify whether the quality of the recalibration is satisfactory in light of a criterion for assessing the quality of the recalibration.

If the recalibration is deemed satisfactory, the depth map CP is generated during step 150.

If the recalibration is not deemed satisfactory, a step 147 for evaluating the ratio between the focal lengths of the monochromatic main image IPM and the corrected slave image IEC is carried out similarly to the aforementioned step 110, but using, in place of the original slave image IE, the corrected slave image IEC2. A process of refining the resizing value to be applied between the slave images IE and the main images IP is carried out, until in a given iteration, the test 145 is found to be positive.

FIG. 5 shows a third embodiment of image processing by the computing unit 13, for the recalibration of the slave images IE.

Like before, the main images IP are subject to an extraction 100 of the luminance component Y. The extraction step 100 makes it possible to have monochromatic main images IPM.

The processing comprises, in parallel with the generating steps 220, a plurality of corrected slave images IEC11, IEC12, . . . IEC1n . . . generated by the application of a plurality of different resizing operations to the slave image IE, the resizing valves for example being chosen regularly over a predefined digital value interval. These generating steps 220 are carried out by the means 131 for performing a digital zoom.

Then, for each of these corrected slave images IEC11, IEC12, IEC13, the processing comprises a step 230 for estimating angular differences, between the image captures, by comparing the corrected slave image IEC11, IEC12, . . . IEC1n and the monochromatic main image IPM. This can be done by extracting points of interest in each image, and performing, for each pair of images made up of a corrected slave image IEC11, . . . and the main image IPM, a combination of the corresponding points of interest. Like before, the points of interest are identified in the corresponding images (with the same date), and the corresponding points are found, through a recognition and matching process.

The processing is completed by an assessment of the quality of the correction by rotation for each of the images IEC11, IEC12, . . . IEC1n. This step can be done simultaneously with the estimating steps 230 of the angular differences, and seeks to evaluate the quality of the match between the main image IPM and each of the corrected slave images IEC11, IEC12, . . . IEC1n, a rotation being allowed between them for the match.

Among the images IEC11, IEC12, . . . IEC1n, that being associated with the best correction is selected during a selection step 240, thus making it possible to choose the best sizing from among the plurality of sizing changes previously used.

This step is carried out by the means 132 for choosing a resizing value.

The processing is continued by a step 245 for applying the associated rotation to the selected corrected slave image IEC11, IEC12, . . . IEC1n, in order to generate a corrected slave image IEC2.

The processing continues with a step 150 for generating a depth map CP (or disparity map), from the monochromatic main image IPM (or optionally the original main map IP) and the corrected slave image IEC2.

The processing also continues by a step 160 for generating a color image integrating the disparity (or depth) RGB-D.

The high-resolution sensor 11 determines the texture of the depth map, and a high performance camera is therefore favored, for example a Full HD 1920×1080 px sensor, with good image sharpness.

The focal distance of the optical zoom associated with the first sensor 11 is preferably chosen by the user. That associated with the second sensor 12 can remain fixed or can vary.

The invention is not limited to the embodiments, but extends to all alternatives in the context of the scope of the claims.

1. A stereoscopic image-capturing apparatus (10) comprising
a first digital image sensor,
a second digital image sensor synchronized with the first digital image sensor,
at least one optical zoom with variable focal distance and associated with the first digital image sensor or the second digital image sensor,
digital zoom means for performing a digital zoom on a digital image coming from the second digital image sensor, wherein
the second digital image sensor is a monochromatic sensor and
the first digital image sensor is a color sensor with a higher resolution than the monochromatic sensor,
means for choosing a resizing value to align an image to be aligned and coming from the first digital image sensor and an image to be aligned and coming from the second digital image sensor, and
means for producing a depth map associated with images captured on the same date by the first and second digital image sensors, using images coming from the second digital image sensor modified by the digital zoom means and resizing by the means for choosing a resizing value, wherein
the means for choosing a resizing value is configured to be implemented at least when the focal distance of the optical zoom is modified, to calibrate the stereoscopic image-capturing apparatus,
the means for choosing a resizing value is configured to be implemented when the stereoscopic image-capturing apparatus is turned on or reset, and
the stereoscopic image-capturing apparatus is powered by an autonomous power source.

2. The stereoscopic image-capturing apparatus according to claim 1, wherein, when the means for producing a depth map is implemented, to produce the depth map, an image coming from the first digital image sensor is rotated with respect to an image coming from the second digital image sensor along at least one and up to three axes.

3. The stereoscopic image-capturing apparatus according to claim 1, wherein the means for choosing a resizing value determines, in order to choose the resizing value, at least one rotation of the image to be aligned and coming from the first digital image sensor relative to the image to be aligned and coming from the second digital image sensor.

4. The stereoscopic image-capturing apparatus according to claim 1, wherein the means for choosing a resizing value uses
an extraction of points of interest of the image to be aligned and coming from the second digital image sensor, as captured by the second digital image sensor, before any resizing, and
an extraction of points of interest of the image to be aligned and coming from the first digital image sensor, and
matching of points of interest taken from the image to be aligned and coming from the second digital image sensor and the image to be aligned and coming from the first digital image sensor.

5. The stereoscopic image-capturing apparatus according to claim 1, wherein the means for choosing a resizing value uses
an extraction of points of interest of the image to be aligned and coming from the second digital image sensor in a form modified at least by the digital zoom means, and
an extraction of points of interest of the image to be aligned and coming from the first digital image sensor, and
matching of the points of interest extracted from the image to be aligned and coming from the second digital image sensor and the image to be aligned and coming from the first digital image sensor.

6. The stereoscopic image-capturing apparatus according to claim 1, wherein the means for selecting a resizing value
implements a plurality of digital zooms with different values on an image captured by the second digital image sensor to obtain a plurality of modified digital images, and
uses a comparison of each of the modified digital images with an image captured by the first digital image sensor.

7. The stereoscopic image-capturing apparatus according to claim 1, wherein the means for choosing a resizing value
implements obtaining, before resizing, a summary resizing value between an image captured by the first digital image sensor, and an image captured by the second digital image sensor, and
refines the summary resizing value into a refined resizing value.

8. The stereoscopic image-capturing apparatus according to claim 2, wherein the means for choosing a resizing value determines, in order to choose the resizing value, at least one rotation of the image to be aligned and coming from the first digital image sensor relative to the image to be aligned and coming from the second digital image sensor.

9. The stereoscopic image-capturing apparatus according to claim 2, wherein the means for choosing a resizing value uses
an extraction of points of interest of the image to be aligned and coming from the second digital image sensor, as captured by the second digital image sensor, before any resizing, and
an extraction of points of interest of the image to be aligned and coming from the first digital image sensor includes matching of points of interest taken from the image to be aligned and coming from the second digital image sensor and the image to be aligned and coming from the first digital image sensor.

10. The stereoscopic image-capturing apparatus according to claim 3, wherein the means for choosing a resizing value uses
an extraction of points of interest of the image to be aligned and coming from the second digital image sensor, as captured by the second digital image sensor, before any resizing, and
an extraction of points of interest of the image to be aligned and coming from the first digital image sensor includes matching of points of interest taken from the image to be aligned and coming from the second digital image sensor and the image to be aligned and coming from the first digital image sensor.

11. The stereoscopic image-capturing apparatus according to claim 2, wherein the means for choosing a resizing value uses
an extraction of points of interest of the image to be aligned and coming from the second digital image sensor in a form modified at least by the digital zoom means, and
an extraction of points of interest of the image to be aligned and coming from the first digital image sensor, and
matching of the points of interest extracted from the image to be aligned and coming from the second digital image sensor and the image to be aligned and coming from the first digital image sensor.

12. The stereoscopic image-capturing apparatus according to claim 3, wherein the means for choosing a resizing value uses
an extraction of points of interest of the image to be aligned and coming from the second digital image sensor in a form modified at least by the digital zoom means, and
an extraction of points of interest of the image to be aligned and coming from the first digital image sensor, and
matching of the points of interest extracted from the image to be aligned and coming from the second digital image sensor and the image to be aligned and coming from the first digital image sensor.

13. The stereoscopic image-capturing apparatus according to claim 2, wherein the means for selecting a resizing value
implements a plurality of digital zooms with different values on the image captured by the second digital image sensor to=obtain a plurality of modified digital images, and
uses a comparison of each of the modified digital images with an image captured by the first digital image sensor.

14. The stereoscopic image-capturing apparatus according to claim 3, wherein the means for selecting a resizing value
implements a plurality of digital zooms with different values on the image captured by the second digital image sensor=to obtain a plurality of modified digital images, and
uses a comparison of each of the modified digital images with an image captured by the first digital image sensor.

15. The stereoscopic image-capturing apparatus according to claim 2, wherein the means for choosing a resizing value
implements obtaining, before resizing, a summary resizing value between an image captured by the first digital image sensor, and an image captured by the second digital image sensor, and
refines the summary resizing value into a refined resizing value.

16. The stereoscopic image-capturing apparatus according to claim 3, wherein the means for choosing a resizing value
implements obtaining, before resizing, a summary resizing value between an image captured by the first digital image sensor, and an image captured by the second digital image sensor, and
refines the summary resizing value into a refined resizing value.
